(19) United States
(12) Patent Application Publication
(10) Pub. No.: US 2011/0220613 A1
(43) Pub. Date: Sep. 15, 2011

(54) ELECTRODE STRUCTURE FOR VACUUM CIRCUIT BREAKER

(75) Inventor: Yoshihiko Matsui, Numazu (JP)

(73) Assignee: JAPAN AE POWER SYSTEMS CORPORATION, Tokyo (JP)

(21) Appl. No.: 13/127,361

(22) PCT Filed: Oct. 2, 2009
(86) PCT No.: PCT/JP2009/067591

§ 371 Date: May 3, 2011

(30) Foreign Application Priority Data
Nov. 4, 2008 (JP) 2008-283008

(51) Int. Cl. H01H 33/66

(52) U.S. Cl. 218/140

(57) ABSTRACT

Contact plate 11 and Contact base for generating axial magnetic field 12 are made of copper-based alloy such as copper-chromium alloy for example. On the periphery of contact base for generating axial magnetic field 12, Outer circumferential section film 17 is provided. Outer circumferential section film 17 is formed by plasma irradiation of chromium that is a arcing part having a melting point higher than the melting point of contact plate 11.

### TECHNICAL FIELD

The present invention relates to an electrode structure for vacuum circuit breaker that makes arc distribute almost evenly on the surface of a contact plate by exposure to a axial magnetic field.

### BACKGROUND ART

For use in a vacuum circuit breaker such that the arc occurred between the breaker's confronting electrode pair is extinguished in vacuum by opening the paired electrodes maintaining the degree of vacuum of the breaker's vacuum chamber, an electrode structure having an improved interrupting capability has been known. Such electrode structure improves the interrupting properties of the circuit breaker by making the arc distribute almost evenly on the surface of a pair of contact plates by a axial magnetic field generated in the axial direction of the electrodes.

As described for example in JP 2003-86068 A1 (Patent literature 1), an electrode structure has been known, which has: a cylindrical contact base that has a plurality of inclined slits formed thereon with a slant with respect to the axis of the contact base; and a contact plate having a plurality of circular slits that extend inwardly from the periphery thereof so that the slits continue to the inclined slits, the contact plate being provided on one end surface of the cylindrical contact base.

In vacuum circuit breakers that employ such type of electrode structure, arc appears between contact plates when the boards are opened on the current interrupting action; the current is however once cut at the time of the current-zero point. Thereafter, the recovery voltage is impressed between the contact plates. Under this situation, the current interrupting successfully completes provided that the dielectric strength across the contact plates is greater than the recovery voltage.

If, however, an operation intends interrupting of a current in excess of the interrupting limit of the circuit breaker in operation, the surfaces of the contact plates would have local-melt lowering dielectric strength between electrodes with a breakdown across contact plates due to the recovery voltage. To improve the current interrupting performance therefore, it is useful to use a hard-to-melt material for the contact plate besides use of a axial magnetic field, as stated above, for a uniform arc distribution.

At the same time, the contact plate is required to provide high-conductivity to assure current carrying performance. To satisfy this requirement, copper-based alloy such as copper-chromium alloy for example is used. The use of copper-chromium alloy, a combination of copper and chromium the melting point of which is higher than that of copper, makes the melting point of the contact plate be higher than that of copper alone, and thereby melting becomes hard to occur.

However, the conventional electrode structure for vacuum circuit breaker sated above is able to prevent the local-melt on the contact plates by stabilizing the arc and uniformizing the arc distribution applying a axial magnetic field. On the contrary, a study on results of an arc observation during an interrupting test performed on an electrode structure for vacuum circuit breaker and a successive disassembling investigation into the tested electrode revealed newly that an interrupting failure caused by a breakdown occurred on the periphery of the contact base arranged behind the contact plate has lowered the interrupting performance.

An object of the present invention is to provide an electrode structure for vacuum circuit breaker that prevents breakdown occurring on the periphery of a contact base arranged behind a contact plate with more improved interruption performance.

### DISCLOSURE OF INVENTION

To attain above-stated object, the present invention provides an electrode structure for vacuum circuit breaker having: a contact plate that works as an arcing part; a contact base for generating a axial magnetic field provided behind the contact plate for applying the axial magnetic field to the arc occurred on the contact plate and an outer circumferential section film of a arcing part having a melting point higher than that of the contact plate is provided on the periphery of the contact base for generating axial magnetic field and is provided at least on the contact plate side thereof.

The outer circumferential section film is preferably a layer formed from the contact plate side to the axial-middle part of the contact base for generating axial magnetic field.

The outer circumferential section film is preferably a layer of chromium or tungsten formed by plasma irradiation.

### EFFECT OF INVENTION

In the electrode structure for vacuum circuit breaker by the present invention, the arc ignited on the outer circumferential section film cannot stably exist as such arc needs high arcing voltage, because the outer circumferential section film of a material having a melting point higher than that of the contact plate is provided on the periphery of the contact base. Therefore, the arc is confined within the confronting area between the contact plates with discharging on the periphery of the contact base prevented. Consequently, the interruption performance can be improved by the stable the axial magnetic field that the contact.

In addition to the above, the electrode structure of the present invention maintains the conductive property of the contact base at a level good enough as before and therefore a stable axial magnetic field can be generated. This is brought about by the feature as follows. The electrode structure does not adopt any change in the constituent material in the contact base, but employs an outer circumferential section film having a higher melting point than that of the contact plate on the periphery of the contact base.

### BRIEF DESCRIPTION OF DRAWINGS

FIG. 1 is a side view of an electrode structure for vacuum circuit breaker in an embodiment of the present invention.

FIG. 2 is a plan view of the electrode structure for vacuum circuit breaker illustrated in FIG. 1.

FIG. 3 is a sectional view of a principal part of a vacuum circuit breaker that employs the electrode structure for vacuum circuit breaker illustrated in FIG. 1.

### BEST MODE FOR CARRYING OUT THE INVENTION

### Embodiment 1

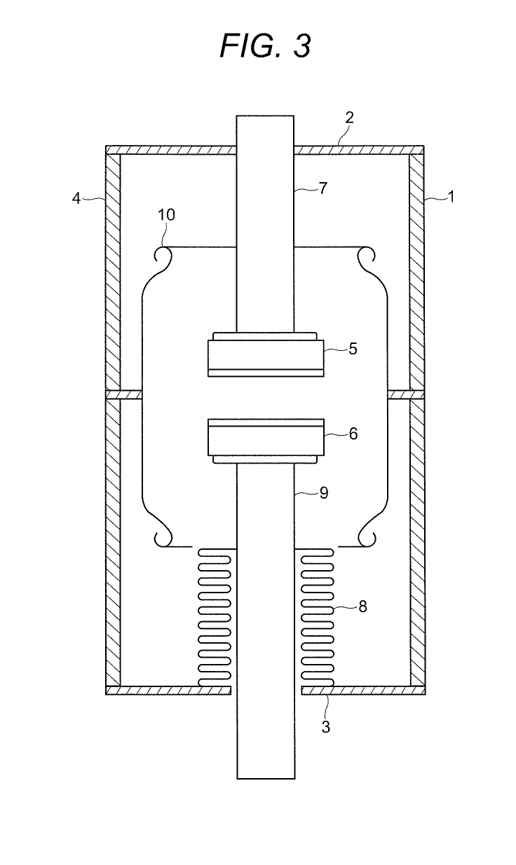

The following provides an explanation of an embodiment of an electrode structure for vacuum circuit breaker by the present invention referring to drawings. The principal part of the vacuum circuit breaker that employs the electrode structure for vacuum circuit breaker in the embodiment by the present invention is illustrated in FIG. 3. Both ends of an insulating cylinder 1 are hermetically sealed with end plates 2 and 3 to form a vacuum container 4. In the vacuum container 4, a couple of electrodes, a fixed-side electrode 5 and a moving-side electrode 6, are arranged confronting each other.

The fixed-side electrode 5 is secured to the end plate 2 through a fixed-side rod 7 while the moving-side electrode 6 is secured to a moving-side rod 9. The moving-side rod 9 is a rod movable in its axial direction maintaining the vacuum of the vacuum container 4 helped by a bellows 8.

The moving-side rod 9 is linked to an operating mechanism (not illustrated), which manipulates the moving-side electrode 6 to cause switching movement of the electrode. On the periphery of both the electrodes 5 and 6, a shield 10 is fixed that protects inner surface of the insulating cylinder 1.

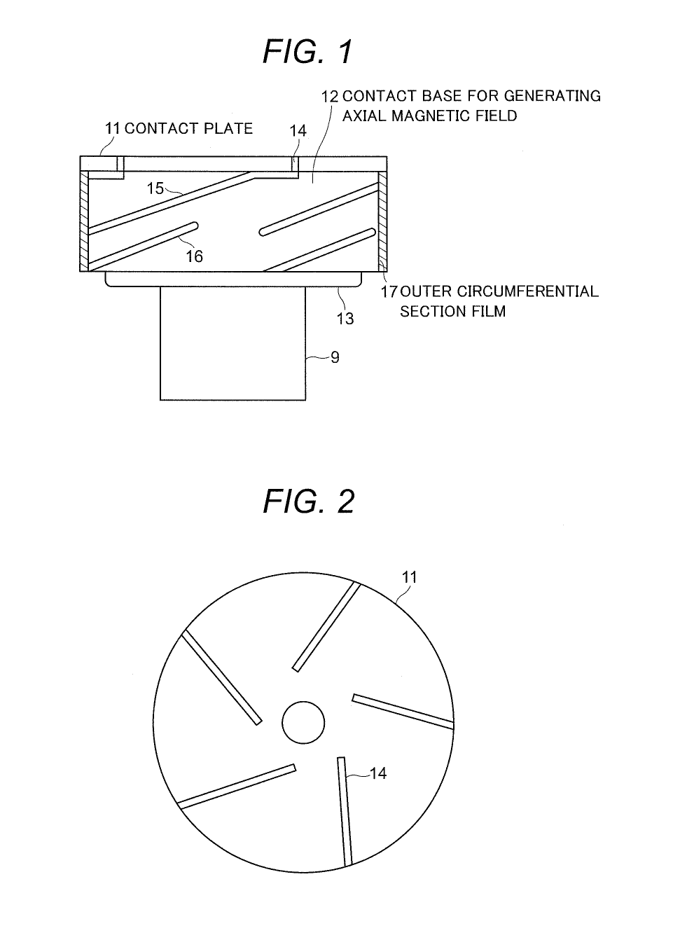

The moving-side electrode 6 stated above is illustrated in FIG. 1 and FIG. 2 in an enlarged manner. The moving-side electrode 6 having a structure similar to that of the fixed-side electrode 5 includes: a plate shaped contact plate 11 provided on the confronting side with the fixed-side electrode 5; a contact base for generating a axial magnetic field 12 of approximately cylindrical shape fixed behind the contact plate 11; and an adapter 13 provided behind the contact base 12. To the adapter 13, the moving-side rod 9 is connected.

On the contact plate 11, a plurality of circumferential slits 14, which extend roughly toward the center of the contact plate 11 from the periphery of the same, are provided at an approximately equal interval. On the contact base 12, a plurality of a slant slit 15 and a plurality of a slant slit 16 are formed at an oblique angle with respect to the axial line of the contact base 12.

The slant slit 15 is formed so that one end thereof will continue to the circumferential slits 14 on the contact plate 11 and so that the other end thereof will reach the mid part of the contact base 12 in the axial direction thereof. The slant slit 16 is formed so that one end thereof will reach the adapter 13 and so that the other end thereof will reach the mid part of the contact base 12 in the axial direction thereof.

The contact plate 11 and the contact 12 stated above are made of copper-based alloy such as copper-chromium alloy for example. On the periphery of the contact base 12, an outer circumferential section film 17 is provided. The outer circumferential section film 17 is made of an arcing part having a melting point higher than that of the contact plate 11 such as chromium (Cr) and tungsten (W) for example.

The outer circumferential section film 17 is provided on the outer surface of the contact base 12 in a form of a layer having a thickness of about 100 μm produced by plasma irradiation of chromium or similar material. Naturally, the forming of the outer circumferential section film 17 is devised so as not to cancel the axial magnetic field generation by the slant slits 15 and 16. The outer circumferential section film 17 may be formed over axially whole of the contact base or may be formed from the contact plate 11 to the axially intermediate point on the contact base 12. In the later arrangement, the limit of area for forming the outer circumferential section film 17 may be determined experimentally according to the phenomenon that will be described later.

As FIG. 2 illustrates, when the moving-side electrode 6 is driven downward for interrupting movement by the operating mechanism (not illustrated), the moving-side electrode 6 separates from the fixed-side electrode 5 generating arc in between. On arcing, the axial magnetic field is generated by the current that flows in a coil-shaped flow path formed by the slant slit 15 and the slant slit 16 formed on the contact base 12, and by the circumferential slit 14 formed on the contact plate 11. This axial magnetic field makes the arc be distributed evenly between the contact plates 11. The arc extinguishes when it experiences the time point of current-zero and then the current ceases to flow under effects rendered by material of the contact plate 11, the vacuum container 4 being vacuum, etc.

A disassembling investigation conducted on electrodes after interrupting tests. According to the tests, their structure is conventional fashion, found evidence of arc discharge on the periphery of the contact base 12 and trail of motion of cathode point. Further, an arc observation with a high-speed video camera revealed that discharge was occurring on the periphery of the contact base 12.

As stated above in contrast in the electrode structure in the embodiment of the present invention, the electrode has the outer circumferential section film 17 on the periphery of the contact base 12. Therefore, the arc ignited on the outer circumferential section film 17 cannot continue to exist stably since the arc on this portion requires higher arcing voltage. As a consequence of this, the arc is confined within the confronting area between the contact plates 11 and accordingly discharging on the periphery of the contact base 12 is prevented.

In addition to the above, the electrode structure of the present invention maintains the conductive property of the contact base 12 at a level good enough as before without the conductive property lowered and therefore a good axial magnetic field can be generated with the current interrupting performance improved. This is brought about by the feature as follows. The electrode structure does not adopt any change in the constituent material in the contact base 12, but employs an outer circumferential section film 17 having a higher melting point than that of the contact plate 11 on the periphery of the contact base 12.

An electrode structure in another embodiment of the present invention may employ contact late 11 with circumferential slit 14 omitted or may employ contact base for generating axial magnetic field 12 having another style of structure for axial magnetic field generation other than a cylindrical type. As for outer circumferential section film 17, another arcing part, not only chromium or tungsten, having a melting point higher than that of the contact plate 11 may be applicable.

### INDUSTRIAL APPLICABILITY

The electrode structure for vacuum circuit breaker by the present invention is applicable not only to a vacuum circuit breaker having the structure illustrated in FIG. 2 but also to a vacuum circuit breaker having other structure than that.

1. An electrode structure for vacuum circuit breaker, the electrode structure comprising:
a contact plate that works as an arcing part;
a contact base for generating a axial magnetic field being provided behind the contact plate, the contact base applying the axial magnetic field to the arc occurred on the contact plate; and
an outer circumferential section film being provided on the periphery of the contact base and being provided at least on the contact plate side thereof,
wherein the outer circumferential section film is made of high-resistance conductor material having a melting point higher than the melting point of the contact plate.

2. The electrode structure for vacuum circuit breaker according to claim 1, wherein the outer circumferential section film is a layer formed from the contact plate side to the axial-middle part on the periphery of the contact base.

3. The electrode structure for vacuum circuit breaker according to claim 1, wherein the outer circumferential section film is a layer of chromium formed by plasma irradiation.

4. The electrode structure for vacuum circuit breaker according to claim 1, wherein the outer circumferential section film is a layer of tungsten formed by plasma irradiation.
